(19) United States
(12) Patent Application Publication
(10) Pub. No.: US 2006/0280120 A1
(43) Pub. Date: Dec. 14, 2006

(54) System and method for managing data packets at an ingress to a Resilient Packet Ring and at an egress to a resilient packet ring

(76) Inventors: Viswanath Ramamurti, Austin, TX (US); John Siwko, Austin, TX (US)

Correspondence Address: BRINKS HOFER GILSON & LIONE, P.O. BOX 10395, CHICAGO, IL, 60610, US

(21) Appl. No.: 11/149,598

(22) Filed: Jun. 10, 2005

(51) Int. Cl. H04J 1/16; H04L 12/56

(52) U.S. Cl. 370/235; 370/412

(57) ABSTRACT

A system and method for managing data packets at an ingress to a Resilient Packet Ring (“RPR”) and an egress to the RPR. A system to manage data packets at an ingress to the RPR comprises a RPR station coupled with a plurality of other stations via a dual ring and a RPR client coupled with at least the RPR station to pass data packets between the RPR station and the RPR client. The RPR client comprises a plurality of client ports that receives at least fairness and non-fairness eligible data to be added to the RPR; a plurality fairness eligible traffic queues, comprising a high and low watermark, each fairness eligible queue associated with one client port to receive fairness eligible data from the client port; and a plurality of local traffic queues, comprising a high and low watermark, to receive non-fairness eligible data form the client port and fairness eligible data from the fairness eligible traffic queue. A system to manage data packets at the egress to the RPR comprises a RPR station in communication with a plurality of other RPR stations via a dual ring and a RPR client in communication with the RPR station to receive data packets from the RPR station. The RPR client comprises a transmit queue, with high and low watermarks, to store data packets from the RPR station for processing.

### BACKGROUND

A Resilient Packet Ring (“RPR”) is a data protocol and topology developed in the Institute of Electrical and Electronic Engineers (“IEEE”) LAN/MAN Standards Committee and published as standard IEEE 802.17. Generally, a RPR is a network topology developed for fiber optic rings. The RPR ring comprises RPR stations connected in a dual (counter rotating) ring structure. Typically, each RPR station is coupled with a RPR client located on the same physical device as the RPR station. The RPR client is additionally coupled with one or more Ethernet (or other communication protocol) interfaces to other external devices or internal modules.

During operation, data packets of a plurality of data types travel along the dual ring structure. At each RPR station, data packets destined for the RPR station are removed from the RPR ring while data packets that are not destined for the RPR station pass though the RPR station. Due to the topology of the ring structure, each RPR station can assume that a data packet sent on the RPR ring will eventually reach its destination RPR station regardless of which path the data packet travels around the RPR ring.

A RPR additionally has the ability to implement fairness algorithms to regulate bandwidth usage by the RPR stations. Typically, a RPR station implements the fairness algorithm to ensure every RPR station has access to an appropriate share of the ring bandwidth.

RPRs do not satisfactorily manage data packets when congestion is detected at an ingress to a RPR or at an egress to a RPR. Congestion at an ingress to a RPR may occur as a consequence of congestion in the RPR throttling the rate that RPR stations admit fairness eligible traffic, or as a consequence of fairness eligible data packets arriving at the ingress to the RPR at a rate greater than the rate that the RPR station can admit fairness eligible traffic into the RPR. When congestion at the ingress to the RPR occurs, fairness eligible data begins to accumulate in the local traffic queues leading to the RPR ring. However, the IEEE standard does not address how to prevent fairness eligible data packets from being dropped from the communications system when the local traffic queues have exceeded their capacity such that the local traffic queues may no longer accept data packets.

The IEEE standard additionally does not address how to prevent data packets from being dropped from the communication system when congestion is detected at a RPR client at an egress to an RPR. The RPR simply assumes that the RPR client can manage all data packets being removed from the RPR ring at the RPR station coupled to the RPR client.

### BRIEF DESCRIPTION OF THE DRAWINGS

FIG. 1 is a diagram of one embodiment of a Resilient Packet Ring (“RPR”) coupled with a plurality of RPR clients;

FIG. 2 is a diagram of one embodiment of an RPR station coupled to an RPR client for managing data packets at an ingress to an RPR when congestion is detected at the RPR client;

FIG. 3 is a flow diagram of a method of an embodiment for managing data packets added to the RPR through the use of a plurality of fairness eligible traffic queues and a plurality of local traffic queues;

FIG. 4 is a diagram of one embodiment of a RPR client coupled to a RPR comprising a transmit queue for managing data packets when congestion is detected at the RPR client at an egress to an RPR; and

FIG. 5 is a flow diagram of a method of an embodiment for managing data packets removed from the RPR ring and passed to the RPR client through the use of a transmit queue.

### DETAILED DESCRIPTION OF THE DRAWINGS AND THE PRESENTLY PREFERRED EMBODIMENTS

The preferred embodiments are directed to a system and method for managing data packets at an ingress to a Resilient Packet Ring (“RPR”) and at an egress to the RPR. The disclosed system provides the ability to manage the number of data packets being added to the RPR in response to congestion at either an ingress or an egress to the RPR. The ability to manage the number of data packets entering the RPR provides the advantage of alleviating congestion at an ingress or egress of the RPR while ensuring no data packets are dropped from the communications system.

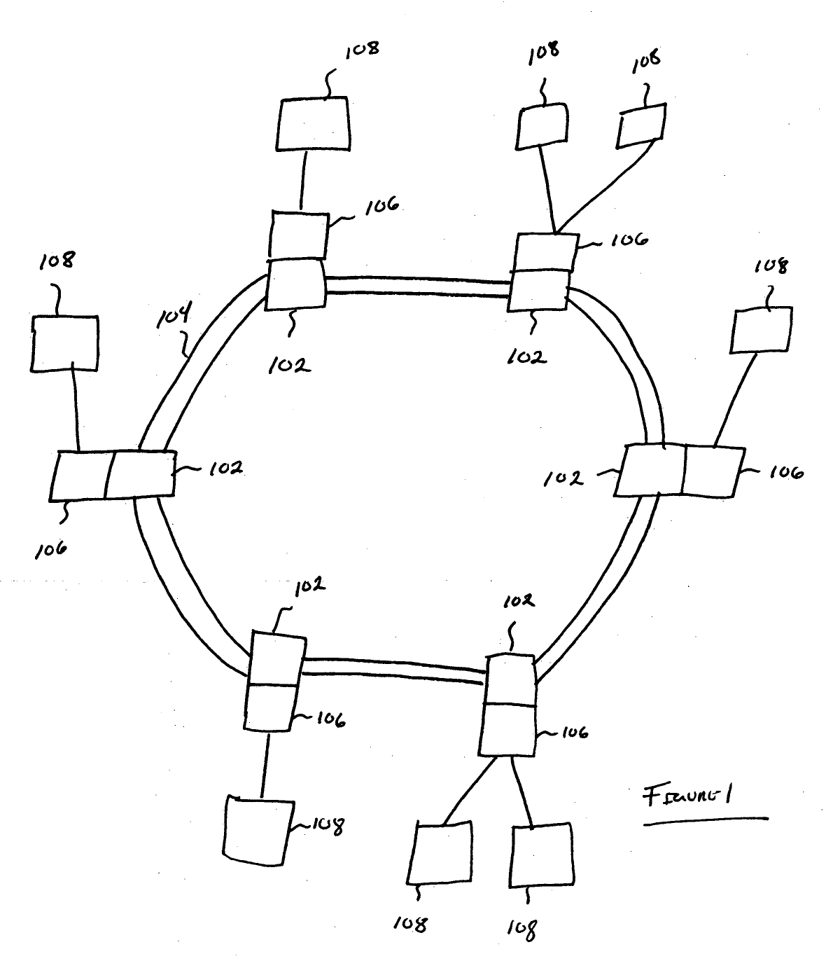

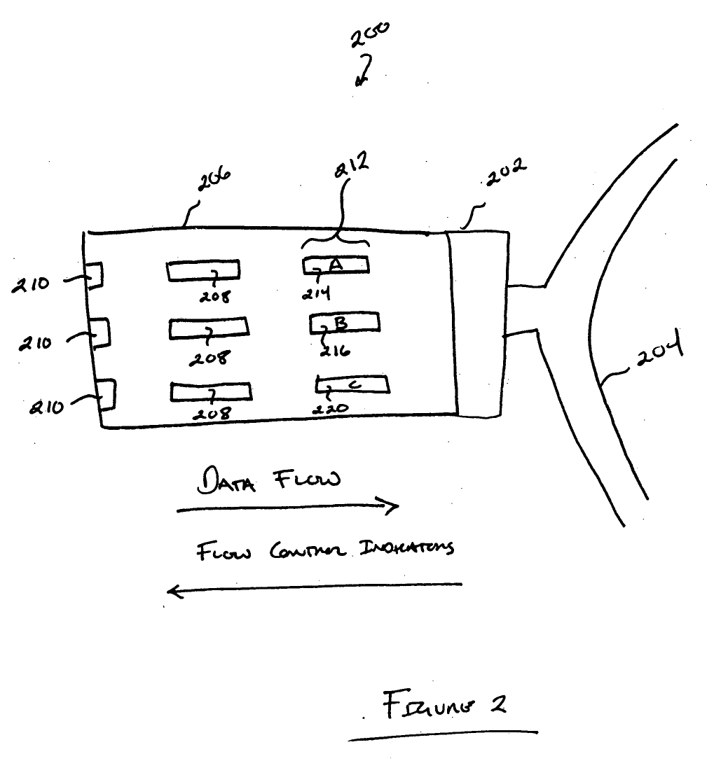

FIG. 1 is a diagram of one embodiment of a system 100 comprising a plurality of RPR stations 102; a data path 104 in a ring topology that is in communication with each of the plurality of RPR stations 102; and a plurality of RPR clients 106, each of which is in communication with at least one of the RPR stations 102.

Generally, data packets travel along the data path 104 to the plurality of RPR stations 102 in either of two directions. At each RPR station 102, data packets destined to that particular RPR station 102 are removed while data packets not destined for that particular RPR station 102 continue along the data path 104 to the next RPR station 102. A data packet removed from the RPR station 102 is typically passed to the RPR client 106 coupled with the RPR station 102. The RPR client 106 may then pass the removed data packet to one or more external communications devices or internal modules 108 through one or more Ethernet (or other communication protocol) interfaces.

Data packets may be added to the data path 104 at each RPR station 102 destined for another RPR station 102. Data packets added to the data path 104 at the RPR station 102 are typically data packets passed to the RPR station 102 from the RPR client 106 coupled with the RPR station 102.

Typically, a plurality of data packet types travel within the RPR. In one embodiment, Class A data is a data packet having minimal latency and minimal jitter, Class B-CIR data is a data packet having bounded latency and bounded jitter, Class B-EIR data is a fairness eligible data packet having no guarantees associated with latency and jitter, and Class C data is a fairness eligible data packet having no guarantees associated with latency and jitter. Fairness eligible data is data whose entrance onto an RPR ring 100 may be delayed to create more bandwidth for other data packets.

Standardized RPR operations ensure that no data packets of any type (Class A, B-CIR, or fairness eligible) are dropped due to congestion within the RPR ring once they have gained entry to an RPR station 102. RPR stations 102 pre-allocate bandwidth for Class A and Class B-CIR data types, so that these data types do not encounter congestion at the ingress RPR client 104 while entering the RPR station 102 (assuming that these data types conform to the agreed-upon Service Level Agreement).

Fairness eligible (Class B-EIR and Class C) traffic, however, may encounter congestion at the ingress RPR client 104 when attempting to enter the RPR station 102. Congestion at the ingress RPR client 104 may occur as a consequence of congestion in the RPR throttling the rate that RPR stations 102 admit fairness eligible traffic, or as a consequence of fairness eligible data packets arriving at the ingress RPR client 104 at a rate greater than the rate that the RPR station 102 can admit fairness eligible traffic into the RPR. Unlike congestion within an RPR, congestion at an ingress RPR client 104 may result in data packets being dropped.

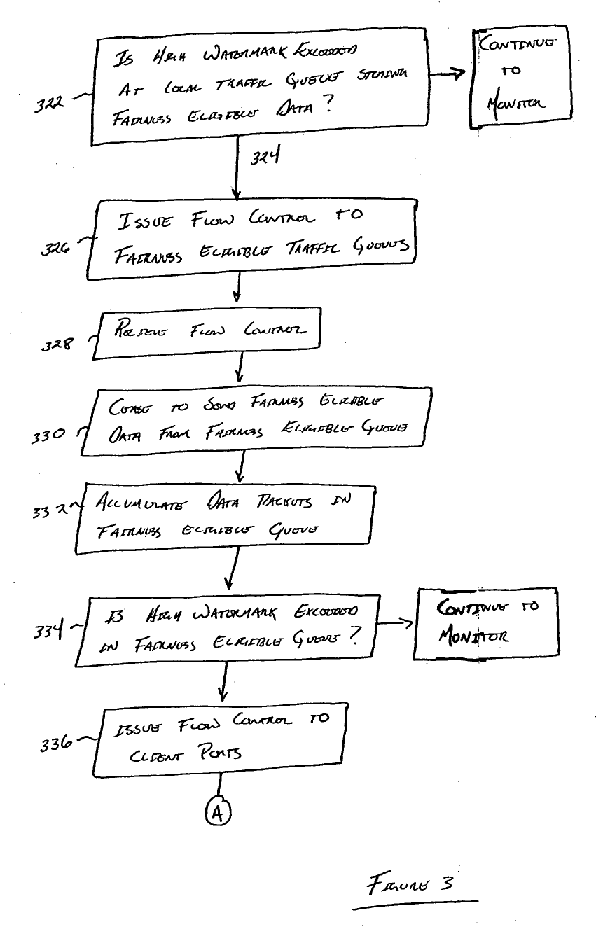

In one embodiment, shown in FIG. 2, to manage data packets being added to the RPR ring 200 during congestion, a plurality of fairness eligible traffic queues 208 with high and low watermarks is placed immediately after a plurality of client ports 210. These fairness eligible traffic queues are used for just the fairness eligible data packets. A traffic queue is a queue implemented using hardware or software that stores data packets for processing at a point within the RPR ring 200. Typically, the queue operates as a first-in-first-out queue as is well known in the art. However in other embodiments, the RPR ring 200 may utilize a last-in-first-out queue or any other type of queue known in the art. The client ports 210 are data ports through which data packets are sent from one or more external communication devices or internal modules coupled with the RPR client 206 to the RPR client 206 to be added to the RPR ring 200 through an RPR station 202.

A watermark is a designation within a queue indicating a level of data packets within a queue. Typically, a high watermark indicates that a queue is nearly full so that when the high watermark is exceeded, the queue may not store any more data packets or may only store relatively little more data packets. A low watermark typically indicates that a queue is nearly empty so that when the number of data packets drops below the low watermark, the queue may store a large number of data packets or the rate of data packets being sent to the queue may be increased.

Each of the plurality of fairness eligible traffic queues 208 corresponds to a single client port 210. In one embodiment, a fairness eligible traffic queue 208 corresponding to a client port 210 may comprise a single traffic queue for all fairness eligible data packets, while in other embodiments, a fairness eligible traffic queue 208 corresponding to a client port 210 may comprise a traffic queue for each fairness eligible data type.

Typically, in an RPR ring 200 with Classes A, B-CIR, B-EIR, and C data packets, due to the fact only Class B-EIR and Class C data packets are fairness eligible, only Class B-EIR and Class C data packets accumulate in the plurality of fairness eligible traffic queues 208. The Class A and Class B-CIR data packets bypass the plurality of fairness eligible traffic queues 208 and proceed directly to the plurality of local traffic queues 212 leading to the RPR ring. Any local traffic queue 212 that may contain fairness eligible traffic will have high and low watermarks. In the current example, the plurality of local traffic queues 212 comprise a Class A local traffic queue 214, a Class B local traffic queue 216, and a Class C local traffic queue 220. Since both the Class B local traffic queue 216 and the Class C local traffic queue 220 may contain fairness eligible traffic, then in this example, both these two local traffic queues would have high and low watermarks.

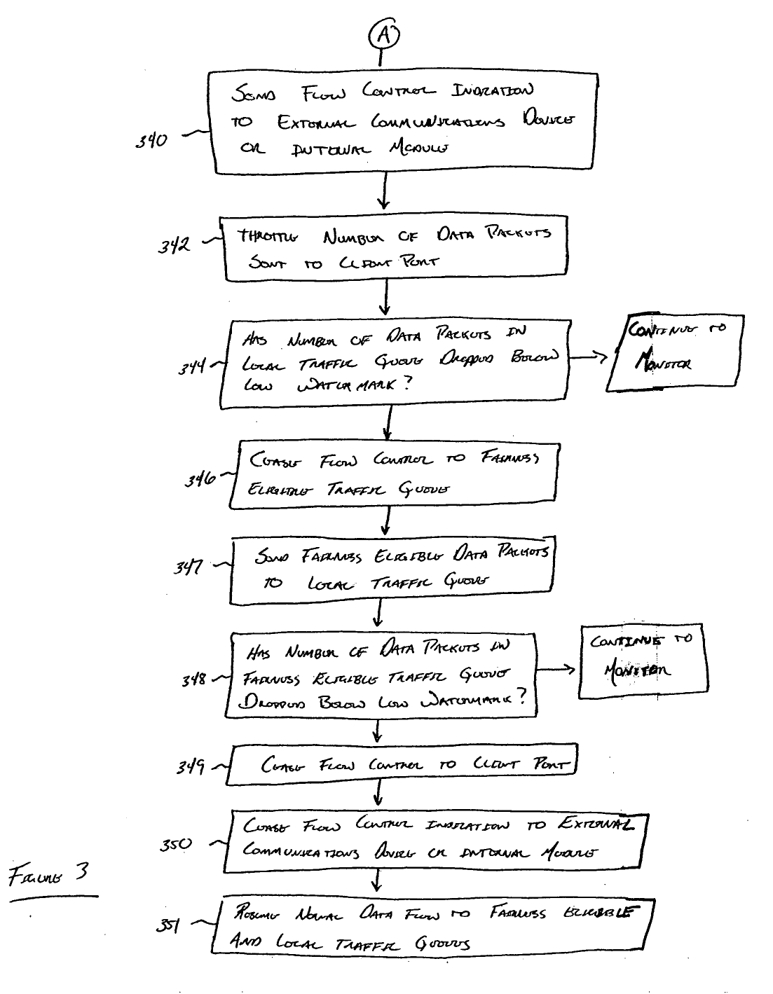

FIG. 3 shows a method 300 of one embodiment for managing data packets through the use of a plurality of fairness eligible traffic queues 208 (FIG. 2) and a plurality of local traffic queues 212 (FIG. 2). Each RPR client monitors the high watermark in Class B and Class C local traffic queues 322. If a high watermark is exceeded in either the Class B or Class C local traffic queues 324, the RPR client issues a flow control indication to each of the plurality of fairness eligible traffic queues leading to the local traffic queues 326. In response to receiving the flow control indication 328, each of the plurality of fairness eligible traffic queues ceases to send fairness eligible data packets to the plurality of local traffic queues leading to the RPR station 330.

As fairness eligible data packets accumulate in the plurality of fairness eligible traffic queues 332, a high watermark of each of the plurality of fairness eligible traffic queues is monitored 334. In one embodiment, the RPR client monitors the fairness eligible traffic queues. However in other embodiments, a process associated with a client port sending data to the fairness eligible traffic queue monitors the high watermark.

If a high watermark of one of the plurality of fairness eligible traffic queues is exceeded, a flow control indication is sent to the client port corresponding to the fairness eligible traffic queue 336 where the high watermark is exceeded.

In response to receiving the flow control indication, the client port sends an appropriate flow control indication to an external client or internal module coupled to the client port 340. The appropriate flow control indication is the flow control indication specified by the protocol used on a particular client port. For example, if the client port is a 1000BASE-LX Ethernet port, the appropriate flow control indication is a PAUSE frame. In response to receiving the flow control indication, the external client or internal module throttles the number of data packets of all data types sent to the client port 342.

When the level of data packets within the Class B and Class C local traffic queues drop below low watermarks 344, the RPR client ceases the flow control to the plurality of fairness eligible traffic queues 346. In response to the flow control ceasing, the fairness eligible traffic queue resumes sending fairness eligible data to the local traffic queues 347.

As each of the plurality of fairness eligible traffic queues resume sending data packets to the local queues, the number of data packets in any given fairness eligible traffic queue may decrease. When the level of fairness eligible data packets within the fairness eligible traffic queue drops below a low watermark 348, flow control to the client port ceases 349. In response to the flow control ceasing, the client port ceases sending a flow control indication to the external client or internal module coupled to the client port 350. In response, a normal data flow of data packets resumes to the local traffic queues and the fairness eligible traffic queue 351.

It will be appreciated that while the method described is for one fairness eligible traffic queue exceeding a high watermark, the above-described method may be simultaneously implemented for multiple fairness eligible traffic queues exceeding their high watermarks at one time.

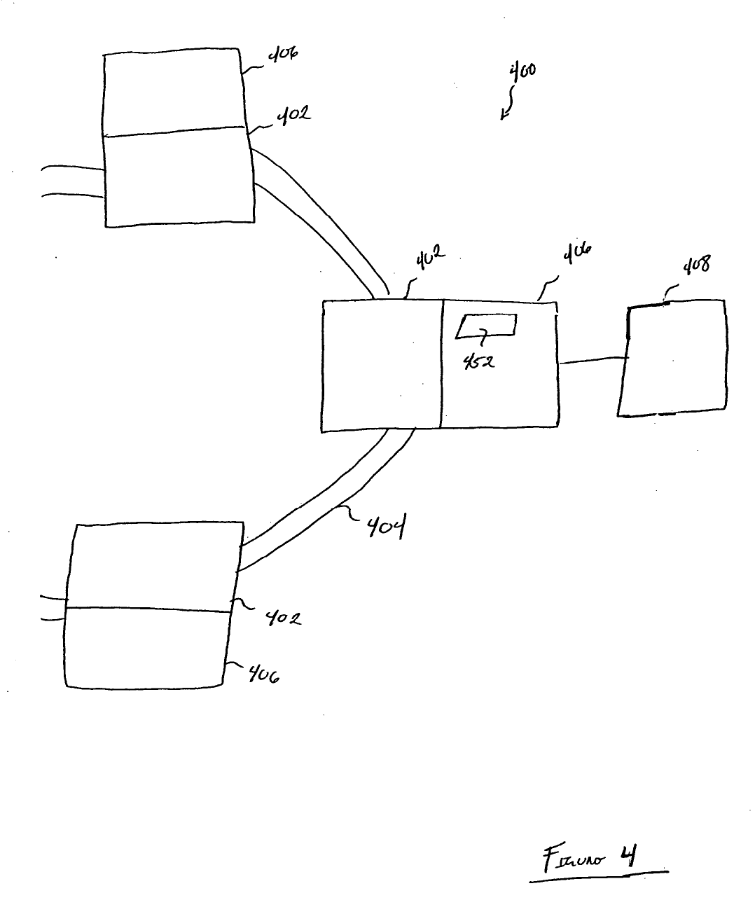

In another embodiment, shown in FIG. 4, to manage data packets when the egress RPR client 406 is congested, a transmit queue 452 with high and low watermarks is coupled with the RPR client 406 such that data packets to be processed by the RPR client 406 may accumulate in the transmit queue 452. Congestion in the RPR client 406 is created when data packets are removed from the RPR ring 400 and passed to the RPR client 406 through the RPR station 402 at a rate greater than the rate at which the RPR client 406 can process data packets. To process the data packets, the RPR client 406 may pass the data packets to one or more external communications devices or internal modules through one or more Ethernet (or other communications protocol) interfaces.

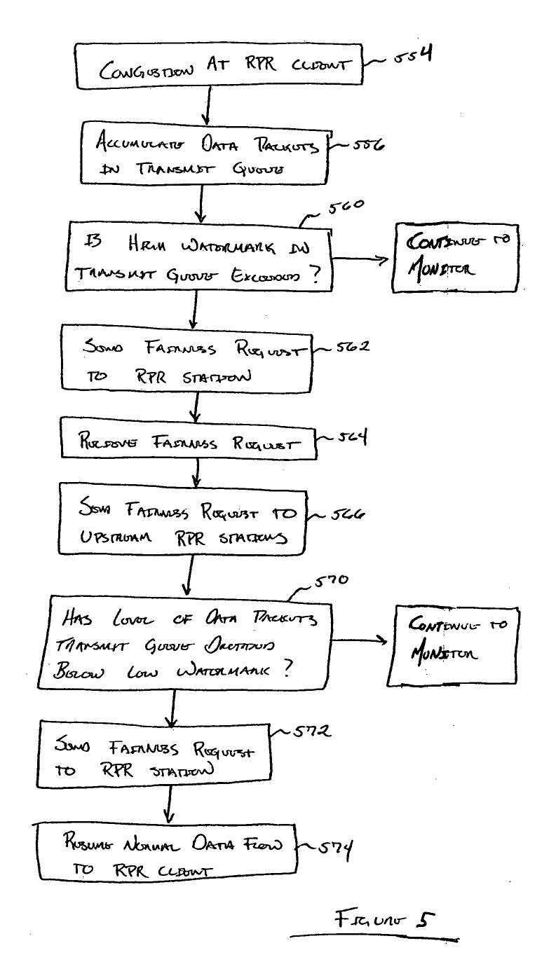

FIG. 5 shows a method 500 of one embodiment for managing data packets removed from the RPR ring 400 (FIG. 4) and passed to the RPR client 406 (FIG. 4) coupled with a transmit queue 452 (FIG. 4). When data packets are removed from the RPR ring at a rate greater than the RPR client can process data packets 554, the excess data packets accumulate in the transmit queue 556.

As data packets accumulate in the transmit queue 556, the RPR client coupled with the transmit queue monitors the high watermark in the transmit queue 560. If the high watermark of the transmit queue is exceeded, a fairness request comprising a rate parameter is sent to the RPR station coupled with the RPR client 562. The rate parameter is typically the maximum rate that the RPR client can process data packets from the RPR station. Thus, the rate parameter effectively informs the RPR station the maximum rate to pass data packets to the RPR client. In response to receiving the fairness request 564, the RPR station coupled to the RPR client sends standard RPR fairness frames to upstream RPR stations requesting a decrease in the number of fairness eligible data packets admitted onto the RPR ring 566. Depending on the method used by upstream RPR stations to admit traffic onto the RPR ring, the upstream stations may reduce the number of fairness eligible data packets destined for the RPR station coupled to the congested egress RPR client, and possibly also those destined for RPR stations downstream from the RPR station coupled to the congested egress RPR client.

As the RPR station passes data packets to the RPR client at a rate below the maximum rate indicated in the rate parameter of the fairness request, the number of data packets within the transmit queue may drop below the low watermark 570. When the RPR client detects the number of data packets has dropped below the low watermark 570, the RPR client sends a second fairness request 572 to the RPR station coupled with the RPR client informing the RPR station that it may send as many data packets to the RPR client as desired. In response, the RPR station uses standard RPR Fairness Algorithms. As a consequence, if the RPR station is not inside any congestion domain in the RPR ring, the RPR station sends fairness frames to upstream RPR stations indicating the upstream RPR station may resume a normal data flow of data packets to the RPR station coupled to the RPR client to be removed from the RPR 574.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories; or a signal containing computer instructions being sent from point A to point B. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

Accordingly, the present invention contemplates a computer readable medium containing instructions, or that which receives and executes instructions from a propagated signal so that a device connected to a network environment can send or receive voice, video or data, and to communicate over the network using the instructions.

Additionally, it will be understood that a device of the present invention includes broadly any electronic device that provides voice, video or data communication, such as a telephone, a cordless telephone, a mobile phone, a cellular telephone, a Personal Digital Assistant (PDA), a set-top box, a computer, and/or a server.

It is therefore intended that the foregoing detailed description be regarded as illustrative rather than limiting, and that it be understood that it is the following claims, including all equivalents, that are intended to define the spirit and scope of this invention.

1. A method for managing data packets at an ingress of a Resilient Packet Ring (“RPR”) comprising:
monitoring a high watermark at each of a plurality of local traffic queues leading to a RPR station that stores fairness eligible data packets;
determining that a number of data packets stored in a first local traffic queue of the plurality of local traffic queues exceeds the high watermark;
issuing a flow control indication to each of a plurality of fairness eligible traffic queues associated with the first local traffic queue;
ceasing to send fairness eligible data packets from the plurality of fairness eligible traffic queues to the first local traffic queue; and
accumulating fairness eligible data packets in the plurality of fairness eligible traffic queues.

2. The method of claim 1, further comprising:
monitoring a high watermark at each of the plurality of fairness eligible traffic queues;
determining that a number of data packets stored in a first fairness eligible traffic queue of the plurality of fairness eligible traffic queues exceeds the high watermark;
sending a flow control indication to a client port associated with the first fairness eligible traffic queue; and
limiting the rate at which an external communications device or internal module coupled with the client port sends data packets to the client port.

3. The method of claim 2, further comprising:
monitoring a low watermark of the first local traffic queue;
determining that the number of data packets stored in the first local traffic queue has fallen below the low watermark;
ceasing to send the flow control indication to each of the plurality of fairness eligible traffic queues associated with the first local traffic queue; and
sending fairness eligible data packets from the plurality of fairness eligible traffic queues storing fairness eligible data packets to the plurality of local traffic queues.

4. The method of claim 3, further comprising:
monitoring a low watermark of the first fairness eligible traffic queue;
determining that the number of data packets stored in the first fairness eligible traffic queue has fallen below the low watermark;
ceasing to send the flow control indication to the client port associated with the first fairness eligible traffic queue; and
removing the limit of the rate at which the external communications device or internal module coupled with the client port may send data packets to the client port.

5. A computer-readable storage medium containing a set of instructions for managing data packets at an ingress to a Resilient Packet Ring (“RPR”), the set of instructions to direct a computer system to perform acts of:
monitoring a high watermark at each of a plurality of local traffic queues leading to a RPR station that stores fairness eligible data packets;
determining that a number of data packets stored in a first local traffic queue of the plurality of local traffic queues exceeds the high watermark; and
issuing a flow control indication to each of a plurality of fairness eligible traffic queues associated with the first local traffic queue to cease sending fairness eligible data packets from the plurality of fairness eligible traffic queues to the first local traffic queue.

6. The computer-readable storage medium of claim 5, the set of instructions to direct the computer system to perform the further acts of:
monitoring a high watermark at each of the plurality of fairness eligible traffic queues;
determining that a number of data packets stored in a first fairness eligible traffic queue of the plurality of fairness eligible traffic queues exceeds the high watermark;
sending a flow control indication to a client port associated with the first fairness eligible traffic queue; and
limiting the rate at which an external communications device or internal module coupled with the client port sends data packets to the client port.

7. The computer-readable storage medium of claim 6, the set of instructions to direct the computer system to perform the further acts of:
monitoring a low watermark of the first local traffic queue;
determining that the number of data packets stored in the first local traffic queue has fallen below the low watermark; and
ceasing to send the flow control indication to each of the plurality of fairness eligible traffic queues associated with the first local traffic queue.

8. The computer-readable storage medium of claim 7, the set of instructions to direct the computer system to perform the further acts of:
monitoring a low watermark of the first fairness eligible traffic queue;
determining that the number of data packets stored in the first fairness eligible traffic queue has fallen below the low watermark;
ceasing to send the flow control indication to the client port associated with the first fairness eligible traffic queue; and
removing the limit of the rate at which the external communications device or internal module coupled with the client port may send data packets to the client port.

9. A system for managing data packets at an ingress of a Resilient Packet Ring (“RPR”) comprising:
a RPR station in communication with a plurality of other RPR stations via a dual ring;
a RPR client coupled with at least the RPR station to pass data packets between the RPR client and the RPR station, the RPR client comprising:
a client port receiving data packets comprising at least fairness eligible data packets and non-fairness eligible data packets from one or more external communication devices or internal modules coupled with the RPR client;
a fairness eligible traffic queue in communication with the client port to receive fairness eligible data packets from the client port, the fairness eligible traffic queue comprising a high watermark and a low watermark; and
a plurality of local data queues in communication with the client port and the fairness eligible traffic queue to receive at least fairness eligible data packets from the fairness eligible traffic queue and receive at least non-fairness eligible data packets from the client port, each of the plurality of local data queues storing fairness eligible data packets comprising a high watermark and a low watermark.

10. The system of claim 9, wherein:
the RPR client is operative to monitor the high watermark of each of the plurality of local data queues storing fairness eligible data packets;
the RPR client is operative to send a flow control indication to at least the fairness eligible traffic queue in response to determining a high watermark of one of the plurality of local data queues storing fairness eligible data packets is exceeded; and
the fairness eligible traffic queue is operative to cease passing fairness eligible data packets to the plurality of local data queues in response to receiving the flow control indication.

11. The system of claim 10, wherein:
the RPR client is operative to monitor the high watermark of at least the fairness eligible traffic queue;
the RPR client is operative to send a flow control indication to the client port in response to determining that the high watermark of the fairness eligible traffic queue is exceeded; and
the client port is operative to limit the rate at which the external communications device or internal module coupled with the client port sends data packets to the RPR client in response to receiving the flow control.

12. The system of claim 11, wherein:
the RPR client is operative to monitor at least the low watermarks of the plurality of local traffic queues storing fairness eligible data packets and to cease sending the flow control indication to the fairness eligible traffic queue in response to determining the number of fairness eligible data packets stored in the plurality of local traffic queues has fallen below the low watermarks; and
the RPR client is operative to monitor at least the low watermark of the fairness eligible traffic queue and to cease sending the flow control to the client port in response to determining the number of fairness eligible data packets stored in the fairness eligible traffic queue has fallen below the low watermark.

13. A method for managing data packets at an egress of a Resilient Packet Ring (“RPR”) comprising:
monitoring a high watermark in a transmit queue associated with a RPR client;
determining that a number of data packets stored in the transmit queue exceeds the high watermark;
sending a first fairness request comprising a rate parameter to a RPR station coupled with the RPR client; and
requesting that RPR stations upstream from the RPR station coupled with the RPR client reduce the admission of fairness eligible traffic to the RPR to a rate that is a function of the rate parameter.

14. The method of claim 13, further comprising:
monitoring a low watermark in the transmit queue;
determining that the number of data packets stored in the transmit queue is below the low watermark;
sending a second fairness request to the RPR station; and
ceasing to request that RPR stations upstream from the RPR station coupled with the client reduce the admission of fairness eligible traffic to the RPR based on the rate parameter

15. The method of claim 13, wherein the high watermark of the transmit queue is exceeded when data packets are removed from the RPR by the RPR station and passed to the RPR client at a rate greater than the rate at which the first RPR client can process the data packets.

16. A system for managing data packets at an egress of a Resilient Packet Ring (“RPR”) comprising:
a RPR station in communication with a plurality of other RPR stations via a dual ring, the RPR station operative to remove data packets from the dual ring;
a RPR client in communication with the RPR station to receive data packets from the RPR station, the RPR client operative to detect congestion at the RPR client; and
a transmit queue in communication with the RPR client to store data packets from the RPR station for processing, the transmit queue comprising a high watermark and a low watermark.

17. The system of claim 16, wherein:
the RPR client is operative to monitor the high watermark of the transmit queue and send a fairness request comprising a rate parameter to the RPR station in response to determining that a number of data packets stored in the transmit queue exceeds the high watermark; and
the RPR station is operative to request that RPR stations upstream from the RPR station reduce the admission of fairness eligible traffic to the RPR to a rate that is a function of the rate parameter.

18. The system of claim 17, wherein:
the RPR client is operative to monitor the low watermark of the transmit queue and send a second fairness request to the RPR station in response to determining that the number of data packets stored in the transmit queue has fallen below the low watermark; and
the RPR station is operative to cease requesting that RPR stations upstream from the RPR station reduce the admission of fairness eligible traffic to the RPR based on the rate parameter.

19. A computer-readable storage medium containing a set of instructions for managing data packets at an egress of a Resilient Packet Ring (“RPR”), the set of instructions to direct a computer system to perform acts of:
monitoring a high watermark in a transmit queue associated with a RPR client;
determining that a number of data packets stored in the transmit queue exceeds the high watermark; and
sending a first fairness request comprising a rate parameter to a RPR station coupled with the RPR client to request that RPR stations upstream from the RPR station coupled with the RPR client reduce the admission of fairness eligible traffic to the RPR to a rate that is a function of the rate parameter.

20. The computer-readable storage medium of claim 19, the set of instructions to direct the computer system to perform the further acts of:
monitoring a low watermark in the transmit queue;
determining that the number of data packets stored in the transmit queue is below the low watermark; and
sending a second fairness request to the RPR station to cease requesting that RPR stations upstream from the RPR station coupled with the RPR client reduce the admission of fairness eligible traffic to the RPR based on the rate parameter.
